(19) United States
(12) Patent Application Publication
(10) Pub. No.: US 2009/0297309 A1
(43) Pub. Date: Dec. 3, 2009

(54) Round cotton module transport

(76) Inventor: Jimmy R. Stover, Corpus Christi, TX (US)

Correspondence Address: G. TURNER MOLLER, JR., 711 NORTH CARANCAHUA, SUITE 720, CORPUS CHRISTI, TX, 78475, US

(21) Appl. No.: 12/156,400

(22) Filed: May 29, 2008

(51) Int. Cl. B65G 15/30; B60P 3/00

(52) U.S. Cl. 414/491; 198/804

(57) ABSTRACT

A roller chain is modified to provide a generally round cleat extending across the top of a pin link. The cleat provides sufficient traction to transport conventional rectangular cotton modules and transport plastic wrapped round cotton modules without producing small plastic pieces that can enter a cotton gin and ruin large batches of cotton. The cleat is conveniently of round metal rod welded to the outside of pin links on the chain. Cleats may be provided on every pin link or on selected ones of pin links of the chain.

This invention relates to an apparatus for transporting a round cotton module wrapped with a plastic cover.

### BACKGROUND OF THE INVENTION

Although this invention has potential application for handling other round bales of fibrous materials, it will mainly be described in conjunction with its most imminent and important application, which is the transportation of round cotton modules.

Handling of seed cotton from the time it is picked, or stripped, in the field until it enters a cotton gin has evolved over the years. Fifty years ago, seed cotton was dumped into small trailers and hauled to the gin. This was supplanted by cotton module technology where cotton from a picker/stripper is delivered to a module builder on the edge of the field. A large rectangular cotton module is made by alternately dumping seed cotton into the builder and then packing the cotton. The module is discharged from the module builder onto the ground and the top is covered with a plastic tarpaulin or cover. Later, the module is picked up by a special module retriever truck and hauled to the gin where it is stored, almost always outside, along with a large number of other modules until the gin is ready to handle this particular module. The module is then picked up by the same or similar module truck and hauled to a module feeder. The plastic cover is removed and the module conveyed to a disperser where the module is disintegrated and the cotton fibers are delivered to the gin. Cotton module technology, expensive as it is, is considerably more efficient, all things considered, than hauling loose cotton in cotton trailers. Accordingly, cotton module technology completely replaced cotton trailers and has been the standard of the industry for several decades.

Current cotton module technology has its problems. A major problem is that module builders discharge the packed cotton module onto the ground at the edge of a field. Even though the cotton is fairly tightly packed and attempts are made to position the cotton modules on fairly high ground, there is always the potential for water to collect around the base of the module and wick up into the module, damaging a bottom layer of the cotton to an extent where it is not ginned. Six inches or a foot of damaged cotton on the bottom of a module will be seen to be a significant part of a module ten feet high. In addition, the plastic covers on top of the module, which are intended to shed water, are not perfect. The worst thing that can happen is for the cover to have, or develop, a hole where rain enters and damages the seed cotton resulting in the loss of an entire module. Conventional rectangular cotton modules weigh in the range of 18,000 to 26,000 pounds and contain 5,000-9,000 pounds of lint cotton so it is easy to see the extent of potential losses.

In response to these problems, there has been developed a system for producing round cotton modules wrapped with a plastic cover. The concept is that the plastic cover protects the module against wicking up water from the underlying ground surface and more effectively sheds rain. This development creates additional problems because the plastic has to be removed from the modules before it enters a gin. In addition, the plastic wrapped modules have to be transported from the field to a storage area or yard near the gin, from the gin yard to the module feeder, along the module feeder conveyor where the plastic is removed and then into a disperser where the cotton module is digested into small clumps suitable for ginning.

Disclosures of interest to this invention are found in U.S. Pat. Nos. 4,081,094; 4,103,794; 5,340,259; 5,795,124; 6,935,827 and 7,225,918.

### SUMMARY OF THE INVENTION

An overriding problem with plastic wrapped cotton modules is that the plastic must be completely removed and not allowed to enter the gin where cotton fibers are separated from cotton seed. The reason is that cotton is used to manufacture threads, yarns and ultimately textiles and the presence of plastic in the ginned cotton is completely unacceptable to textile manufacturers because it will ruin large batches of produced yarn and/or textiles, mainly because it will not take dyes and other textile treatments.

The need to remove the plastic wrap without creating small plastic pieces that enter the gin has caused the development of large complicated equipment such as shown in copending U.S. applications Ser. Nos. 11/350,314 and 11/904,208. It has been discovered that the plastic removal system is not the only source where small pieces of the plastic cover may be created. When an attempt is made to use conventional chain conveyors for transporting plastic wrapped cotton modules, there is a problem because the chains tear the plastic wrap and produce small plastic pieces that are prone to enter the gin and ruin large batches of cotton.

In this invention, a roller chain is modified in such a manner that it provides sufficient traction to move a plastic wrapped round cotton module into and out of a cotton module truck or on a chain bed type module feeder with minimum tearing of the plastic wrap and without producing small pieces of plastic that can adhere to the cotton and pass into the gin. In addition, the roller chain produces sufficient traction that it can successfully transport, load and unload conventional rectangular cotton modules.

The roller chain is modified by providing a generally U-shaped round cleat welded to the sides of the pin links and extending transverse to the direction of travel of the chain. The cleat presents an arcuate, preferably round, upper side and a convex lower side. The vertical sides of the cleat are welded to the pin links and are tapered. A roller chain of this type is successful to transport, load and unload plastic wrapped cotton modules without tearing the plastic and successful to transport, load and unload conventional rectangular cotton modules on cotton module trucks and on module feeder conveyors.

It is an object of this invention to provide an improved roller chain for moving plastic wrapped cotton modules and conventional rectangular cotton modules.

It is a further object of this invention to provide an improved roller chain having a round cleat extending over the top of pin links of the chain.

These and other objects and advantages of this invention will become more fully apparent as this description proceeds, reference being made to the accompanying drawings and appended claims.

### BRIEF DESCRIPTION OF THE DRAWINGS

FIG. 1 is a side view of a conventional cotton module truck;

FIG. 2 is a top view of a conventional cotton module truck with the cover removed;

FIG. 3 is an enlarged cross-sectional view of the cotton module truck of FIGS. 1 and 2, taken substantially along line 3-3 of FIG. 2, as viewed in the direction indicated by the arrows;

FIG. 4 is a view of the sprocket end of the conveyor, part of the chain and part of the sprocket being broken away for clarity of illustration;

FIG. 5 is an enlarged isometric view of a roller chain of this invention;

FIG. 6 is an enlarged top view of the chain of FIG. 6;

FIG. 7 is an enlarged side view of the chain of FIGS. 5 and 6;

FIG. 8 is a cross-sectional view of the chain of FIG. 6, taken substantially along line 8-8 thereof as viewed in the direction indicated by the arrows;

FIG. 9 is a cross-sectional view of the chain of FIG. 8 taken substantially along line 9-9 thereof as viewed in the direction indicated by the arrows;

FIG. 10 is a cross-sectional view, analogous to FIG. 9, of a cleat of somewhat different shape;

FIG. 11 is an isometric view, similar to FIG. 5, of a slightly different chain of this invention;

FIG. 12 is a side view, similar to FIG. 7, illustrating the chain of FIG. 11;

FIG. 13 is a cross-sectional view, similar to FIG. 4, illustrating part of a conveyor usable with the chain of FIG. 11; and

FIG. 14 is a pictorial view of a module feeder for handling plastic wrapped round cotton modules.

### DETAILED DESCRIPTION

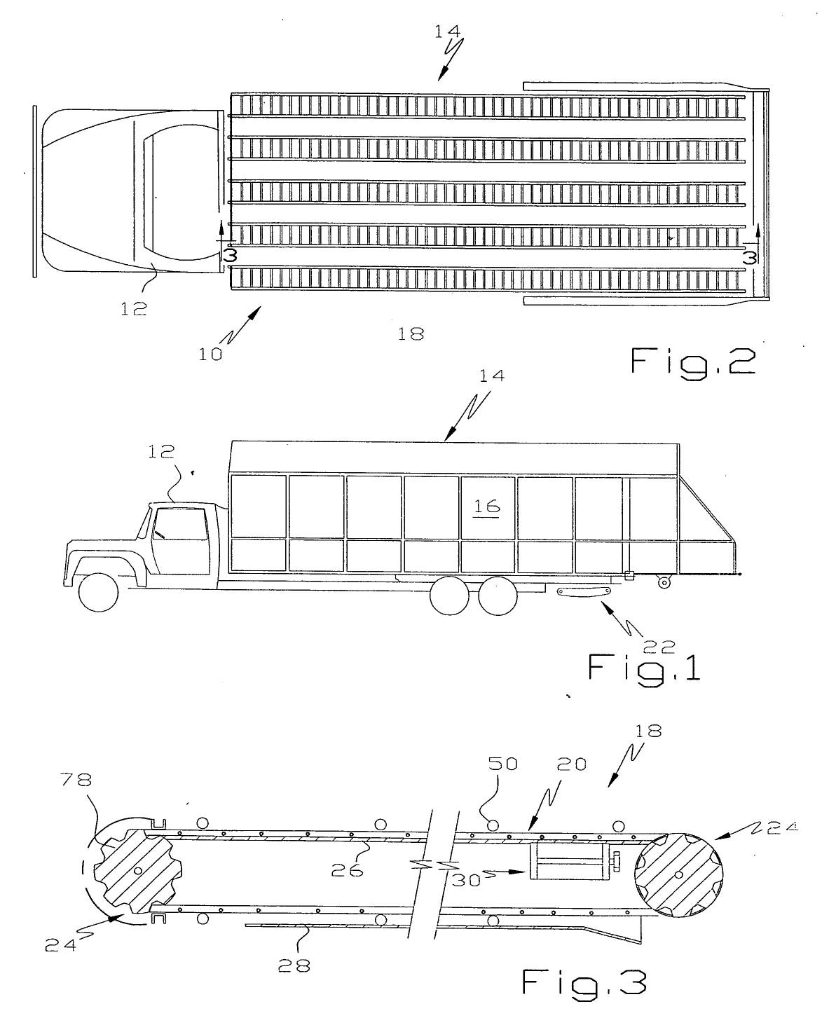

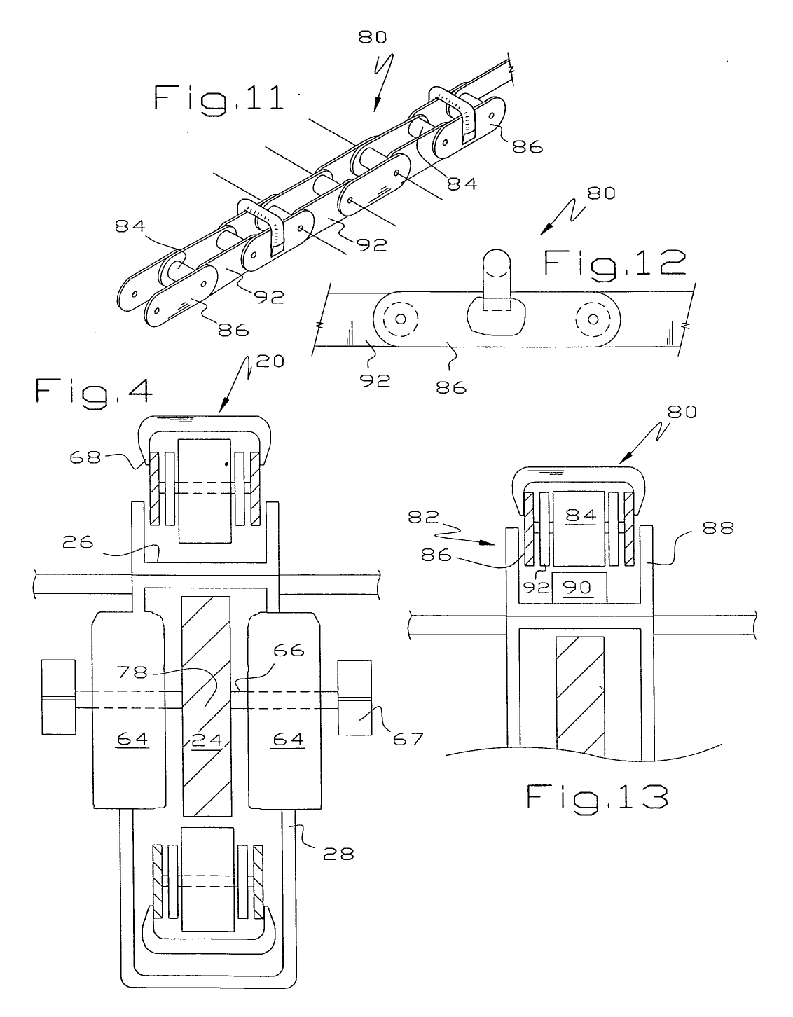

Referring to FIGS. 1-3, there is illustrated a conventional cotton module truck 10 having a cab 12 and a tiltable body 14 including a cover 16 and a conveyor 18 on the body 14 having a series of roller chains 20 for loading and unloading cotton modules into the truck 10. A supplemental drive or crawler mechanism 22 is provided near the rear of the body 14 to assist rearward movement of the truck 10 when picking modules up off an underlying ground surface.

Referring to FIGS. 3-4, one of the conveying chains 20 is illustrated in greater detail. In some embodiments, the chain 20 is mounted on sprockets 24 for movement over a channel or solid frame 26 where the weight of a cotton module is supported and, in a return direction, through a tube or box 28. An adjustment mechanism 30 is typically provided to independently adjust the tension in each chain 20. The chain 20 is driven, typically by a power take off from the engine of the truck 10, so a cotton module is picked up off an underlying ground and elevated up the ramp provided by the tilted bed 14 into the housing 16. When it is desired to unload the cotton module, the bed 14 is tilted and the chain driven in the opposite direction. Those skilled in the art will recognize the truck 10, chain bed conveyor 18 and chain 20, as heretofore described, as being typical of modern cotton module trucks. Conventional cotton module trucks are available from several manufacturers including Stover Equipment Company of Corpus Christi, Tex. to which reference is made for a more complete description of the truck 10 and chain bed conveyor 18.

Conventional chain bed conveyor chains for use on cotton module trucks and in cotton module feeders are equipped with a sharp cleat as shown, for example, in U.S. Pat. No. 4,081,094 in order to provide sufficient traction to move a conventional rectangular cotton module up the incline provided by the tilted body 14 when picking a module off the ground. It has been learned that standard cleats cannot be used when handling plastic wrapped round cotton modules because the cleats tear the plastic wrap and produce small plastic pieces that are prone to enter the cotton gin and ruin large batches of ginned cotton. One original attempt to overcome this problem is shown in applications Ser. Nos. 11/350,314 and 11/904,208. Although this approach has proved successful, this invention is an improvement thereon.

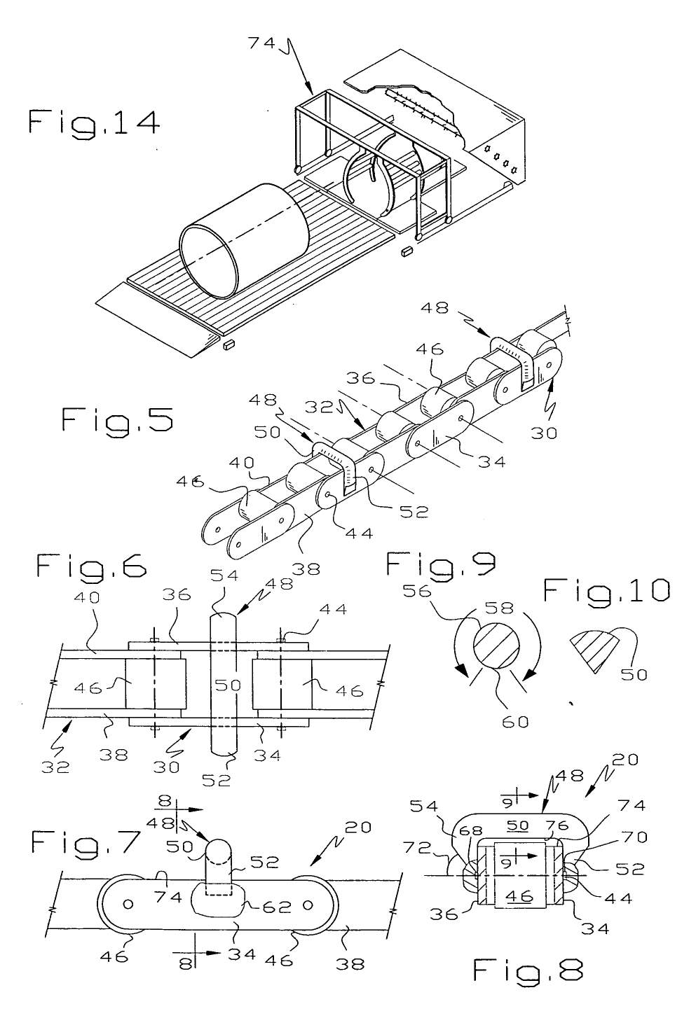

The roller chain 20 comprises an alternating series of pin links 30 each providing pairs of links 34, 36 and roller links 38 each providing pairs of links 40, 42. The links 34, 36, 40, 42 are connected by pins 44 on which are mounted rollers 46 of a diameter sufficient to support the load of a cotton module from an underlying frame. In the embodiment of FIGS. 5-8, the rollers 46 extend below a bottom surface of the links 34, 36, 40, 42 into load supporting engagement with the frame 26. A typical roller chain used in cotton module trucks in the United States goes by the industry designation as 20:62 H where “20” means double pitch where pitch is the length between pins, “6” means pitch length and “2” means a roller large enough to extend below the bottom of the chain link and “H” means heavy gauge rather than standard gauge. In Australia and other countries, a typical roller chain used in cotton module trucks goes by the industry designation of 20:82 H where “20” means again means double pitch, “8” means pitch length and “2∞ means a large roller. Those skilled in the art will recognize the chain 20, as heretofore described, as being typical of modern roller chains.

As shown in FIGS. 5-9, a cleat 48 of this invention is attached to selected ones of the chain links to provide sufficient traction to convey round cotton modules without producing small plastic pieces and provide sufficient traction to convey conventional rectangular cotton modules. To this end, the cleat 48 is of inverted shallow U-shape having a central pusher section 50 and a pair of legs 52, 54 that are welded to the outside surface of selected ones of the links 34, 36. Depending on the design maximum weight of the cotton module, the angle of the titled bed, the number of conveyor chains and other features of the truck design, a selection is made of how many cleats 48 are incorporated into the chain 20. In some situations, it may be desirable to provide each pin link 30 and each roller link 38 with a cleat 48. In other situations, every, every other, every third, every fourth or every fifth pin link will be satisfactory. So far, every other or every third pin link has proved satisfactory. In some embodiments, the cleat 48 may be welded to the links 38, 40 of the roller pair 32 although it is preferred to weld them to the links 38, 40 of the pin links because the cleats 48 are wider and there is more room to do the welding.

The central pusher section 50 is arcuately convex on its upper surface in a plane parallel to the direction of movement of the chain 20 as shown in FIGS. 9 and 10. Although the pusher section 50 is conveniently circular or completely round as shown in FIG. 9, it is not necessarily round on the bottom of the pusher section 50 as shown in FIG. 10. For purposes of minimizing tearing of the plastic wrap, the only part of the pusher section 50 that contacts a plastic wrapped cotton module is its upper surface, meaning that its bottom surface may be of a different configuration.

As shown best in FIG. 9, the central pusher section 50 has an arcuate or rounded upper surface 56 extending in a preferred arc 58 counterclockwise from about the 4 o'clock position to about the 8 o'clock position. The purpose of the arcuate surface 56 is to provide sufficient traction to handle conventional rectangular cotton modules without tearing the plastic wrap when handling round cotton modules. Because the conveyors of cotton module trucks load and unload round cotton modules, the surface 56 is preferably symmetrical to provide equal traction and equal ability not to tear plastic in both directions of movement of the chain 20.

Although the under surface 60 of the pusher section 50 may be of any desired shape, it is preferably downwardly convex to minimize cotton from collecting and being trapped in the chain 20. Too much cotton trapped on the inside of a particular link will cause the chain 20 to overtighten when the link goes across the end of the sprocket 24 which can either break the chain or dislodge the chain from the sprocket. Thus, the under surface 60 of the pusher section 50 is preferably either arcuately downwardly convex as shown in FIG. 9 or pointed and downward convex as shown in FIG. 10 which illustrates an alternate cross-section for a central pusher section 50′ of this invention. A flat or downwardly concave under surface of the central section 50 tends to accumulate cotton and cause problems. It will be seen that the central pusher section 50 is preferably circular in cross-section as shown in FIG. 9 and is conveniently made from a round metal rod that is bent and cut into the desired shape. Although considerable variation in size is feasible, a preferred size is ⅜″ diameter.

The inside surface of the legs 52, 54 of the cleat 48 abut or nearly abut the outside surface of the links 34, 36. The outside surface of the legs 52, 54 are angled or tapered as shown best in FIG. 8. The purpose is two fold. The legs 52, 54 should extend downwardly along the outside surface of the links 34, 36 to provide sufficient room and sufficient material for a weldment 62 to securely affix the cleat 48 to the outside of the links 34, 36.

At the same time, the legs 52, 54 cannot interfere with the sprocket 24 or a bearing housing 64 shown best in FIG. 4 through which extends a shaft 66 rotatably mounting the sprocket 24 and a pair of paddles 67. Tapering the cleat ends 52, 54 and providing a blunt end 68, 70 accomplishes both purposes. The angle of the taper is subject to considerable variation, i.e. the angle 72 may vary from about 20-80° and is preferably in the range of 50-70° and ideally is about 60°. To provide the necessary clearance, the taper usually begins at about the top 74 of the links 34, 36 as shown best in FIGS. 7 and 8.

Another important feature of the cleat 48 is the position of the lowermost surface 76 of the central pusher section 50. In the United States, conventional sprockets have teeth that are long enough to strike the pusher section 50 if the lowermost surface 76 were on the top 74 of the links 34, 36. Thus, in the United States, using standard conventional sockets, the central pusher section 50 is desirably raised above the top 74 of the links 34, 36 as shown best in FIG. 8 to prevent any of the sprocket teeth 78 from contacting the central pusher section 50 when its link goes across the sprocket 24. Although the elevation of the central pusher section 50 above the top 68 of the links is subject to considerable variation, anything less than about ⅛″ is not currently desirable because the sprocket teeth of some currently available cotton module trucks stick up above the tops 68 of the links by about ⅛″. In other words, anything shorter will not universally fit all sprockets on currently available cotton module trucks in the United States. The maximum dimension between the bottom of the central pusher section 50 and the top 68 of the links 34, 36 is subject to wider variation because the only real limiting factor is the size of the tube or channel 28 on the return leg of the conveyor 18 and the tendency of too large a cleat 48 to puncture the plastic wrap. Thus, the clearance dimension between the bottom of the pusher section 50 and the top 68 of the links 34, 36 is less than one half inch. The situation is different in Australia because the industry standard is to use shorter sprocket teeth that do not extend above the top of the links 34, 36. Thus, in Australia, or with non-standard U.S. sprockets, the lowermost surface 76 of the pusher section 50 may be flush with the top of the links 34, 36.

An advantage of the chain 20 compared to the prior art chains shown in applications Ser. Nos. 11/350,314 and 11/904,208 is wear on the tube or box 28. In these prior art chains, each prior art link contacts the tube and tends to wear a pair of parallel elongate slots in the tube or box 28. In this invention, the round cleat 48 tends to spread out wear on the tube or channel 28 so it does not wear rapidly.

Referring to FIGS. 11-13, a slightly modified chain 80 and support frame 82 are illustrated. In the embodiment of FIGS. 5-10, the rollers 46 are sufficiently large to extend below the links 34, 36, 38, 40 and thereby support a cotton module on a flat underlying surface, such as the bottom of the channel 26 shown in FIG. 4. In the embodiment of FIGS. 11-13, the rollers 84 are smaller and do not extend below the bottom of the links 86. Thus, the support frame 82 is slightly different, i.e. it comprises a channel or guide 88 limiting side-to-side movement of the chain 80 and a flat support bar 90 elevating the center of the channel 88 so the rollers 84, not the links 86, 92 support a cotton module from the frame 82.

Referring to FIG. 14, there is disclosed a module feeder 92 of the type shown in application Ser. Nos. 11/350,314 and 11/904,208 which comprises as major components, a conveyor 94, a gantry 96 incorporating the components for removing a plastic cover 98 from a round cotton module 100 and a disperser 102 for digesting cotton from the module 100 into clumps of a size that can be processed by a cotton gin. As illustrated, the conveyor 94 comprises a series of conveying chains 104 of the type shown in FIGS. 4-13 which are driven by a sprocket arrangement similar to that shown in FIGS. 4 and 13.

Although this invention has been disclosed and described in its preferred forms with a certain degree of particularity, it is understood that the present disclosure of the preferred forms is only by way of example and that numerous changes in the details of operation and in the combination and arrangement of parts may be resorted to without departing from the spirit and scope of the invention as hereinafter claimed.

I claim:

1. A cotton module vehicle comprising a tiltable bed having a chain bed conveyor thereon, the chain bed conveyor comprising
a load supporting frame, and
a multiplicity of endless roller chains providing a series of interconnected link pairs and rollers in engagement with the frame for supporting a cotton module thereon,
at least some of the link pairs having an inverted U-shaped pusher element including a central section extending across an upper surface of the link pairs and a pair of tapered end sections welded to opposed ones of the link pairs, the end sections have one side abutted against an outside face of the link pairs and an opposite side tapered between 20-70°,
an upper surface of the central pusher section being arcuately convex upwardly in a plane parallel to a direction of movement of the chains.

2. The cotton module vehicle of claim 1 wherein the vehicle comprises a self propelled cotton module truck.

3. The cotton module vehicle of claim 9 wherein the end sections are tapered between 60-70°.

4. The cotton module vehicle of claim 1 wherein the central pusher section provides a lower surface spaced above the upper surface of the link pairs.

5. The cotton module vehicle of claim 1 wherein the rollers do not extend below an underside of the link pairs and the load supporting frame comprises an elevated central section in engagement with the rollers.

6. A cotton module feeder comprising a disperser and a chain bed conveyor for delivering cotton modules into the disperser and a chain bed conveyor for delivering cotton modules into the disperser, the chain bed conveyor comprising
a load supporting frame, and
a multiplicity of endless roller chains providing a series of interconnected link pairs and rollers extending below an underside of the link pairs in engagement with the frame for supporting a cotton module thereon,
at least some of the link pairs having an inverted U-shaped pusher element including a central section extending across an upper surface of the link pairs and a pair of tapered end sections welded to opposed ones of the link pairs, the end sections have one side abutted against an outside face of the link pairs and an opposite side tapered between 20-70°,
an upper surface of the central pusher section being arcuately convex upwardly in a plane parallel to a direction of movement of the chains.

7. The cotton module vehicle of claim 6 wherein the end sections are tapered between 50-70°.

8. The cotton module vehicle of claim 6 wherein the central pusher section comprises a lower surface spaced above the upper surface of the link pairs.

9. The cotton module vehicle of claim 6 wherein the rollers do not extend below an underside of the link pairs and the load supporting frame comprises an elevated central section in engagement with the rollers.

10. A chain for conveying cotton modules, comprising
a roller chains providing a series of interconnected link pairs and rollers for engaging a frame for supporting a cotton module thereon,
at least some of the link pairs having an inverted U-shaped pusher element including a central section extending across an upper surface of the link pairs and a pair of tapered end sections welded to opposed ones of the link pairs, the end sections have one side abutted against an outside face of the link pairs and an opposite side tapered between 20-80°,
an upper surface of the central pusher section being arcuately convex upwardly in a plane parallel to a direction of movement of the chains.

11. The cotton module vehicle of claim 10 wherein the end sections are tapered between 60-70°.

12. The cotton module vehicle of claim 10 wherein the central pusher section comprises a lower surface spaced above the upper surface of the link pairs.

13. The cotton module vehicle of claim 10 wherein the rollers do not extend below an underside of the link pairs and the load supporting frame comprises an elevated central section in engagement with the rollers.
